(19) United States
(12) Patent Application Publication
(10) Pub. No.: US 2023/0298066 A1
(43) Pub. Date: Sep. 21, 2023

(54) CREDIT CARD DISCOUNTS THROUGH COMBINED DISCOUNTS, COUPON CODES, AND SPECIAL VENDOR OFFERS

(71) Applicant: CREDITCARDNINJAS LLC, Fort Lauderdale, FL (US)

(72) Inventor: Alexander Daskaloff, Fort Lauderdale, FL (US)

(73) Assignee: CREDITCARDNINJAS LLC, FORT LAUDERDALE, FL (US)

(21) Appl. No.: 17/952,988

(22) Filed: Sep. 26, 2022

Related U.S. Application Data
(60) Provisional application No. 63/247,941, filed on Sep. 24, 2021.

(51) Int. Cl. G06Q 30/0207

(52) U.S. Cl. CPC G06Q 30/0236; G06Q 30/0215

(57) ABSTRACT

The invention disclosed here presents a technological improvement over the current state of the art in that the systems and methods disclosed automatically identifies, curates, aggregates, and applies multiple discounts as one optimal credit card discount for use in an online shopping environment. No current solution aggregates and presents all of the available credit card discounts provided by multiple sources such as banks and card issuers in one location.

### CROSS-REFERENCE TO RELATED APPLICATIONS

This patent application is a non-provisional of prior-filed and co-pending U.S. Provisional Patent Application No. 63/247,941 filed on Sep. 24, 2021, which application is incorporated by reference as if fully set forth herein.

### FIELD OF THE INVENTION

The present invention generally relates to a software method and more specifically relates to a method and related system for determining and applying an optimal credit card discount.

### BACKGROUND OF THE INVENTION

There is no online source that reveals all of the available credit card discounts provided by multiple sources such as banks and card issuers in one location. To see what discounts are available, a consumer has to log in to dozens of accounts to see each separate offer. For example, to see American Express discounts, a user must log into American Express, to see Visa discounts, a user must log into Visa, to see if there are bank offers, the user must log into bank sites, and to see if there are vendor specific discounts, a user has to search online or see if the Vendor offers discounts. Some sites show coupon codes, while other sites show discounts for vendors, but no site has the ability to aggregate multiple levels of discounts.

There exists, therefore, a need for a method and related system to overcome the above-stated shortcomings of the known art.

### SUMMARY OF THE INVENTION

The invention disclosed here presents a technological improvement over the current state of the art in that the systems and methods disclosed automatically identifies, curates, aggregates, and applies multiple discounts as one optimal credit card discount for use in an online shopping environment. No current solution aggregates and presents all of the available credit card discounts provided by multiple sources such as banks and card issuers in one location.

Briefly, according to an embodiment, multiple levels, or types, of discount data are collected from various sources. Typically these sources are credit card issuer websites, vendor websites, and the like. But, it is contemplated that other sources of discount data may be collected, such as though direct marketing and business arrangements with credit card issuers, vendor, and merchants. This collected discount data is stored and catalogued in a database, but it is not stagnant. Specifically, the discount data is dynamically updated so that the most current discounts are always stored in the database. After collecting the discount data, the data is combined, analyzed and cross-reference. In this way, when a user accesses the invention in relation to a purchase, the invention can navigate through the discount data and present an optimized combination of multiple discount offers that are then stacked, or combined, in order to present to the user the best single, aggregated, discount possible.

The invention may be implemented as a computer program product, a computer implemented method, or as a system including a computing environment that performs the method steps. A user may interact with the invention via an internet-connected browser, a mobile device running a mobile application, or at a computer terminal.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a high-level simplified view of a discount optimization system for determining an optimal credit card discount, according to an embodiment;

FIG. 2 is a high-level operational flow diagram of a method for determining and applying an optimal credit card discount, according to an embodiment; and

FIG. 3 is a simplified illustration of a browser plug-in for implementing a method according to an embodiment.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We disclose a discount optimization method that employs a technological improvement over the prior art to combine multiple levels of discounts to present to a consumer, via a network connected application interface, the best discount available when making a credit card purchase online. Offers are obtained from multiple sources, and aggregated in one location. To be able to see the discounts, a user needs to be approved for a publisher account for an affiliate network, to get additional discounts that are through a Membership Platform, that are then combined with their other available offers.

The method combines all discounts from the following sources, and makes them visible to the user online via a single application interface:
1. Credit card issuers;
2. Banks;
3. Vendors;
4. Affiliate network promotion Feed.

An affiliate network is an on-line platform that brings advertisers together with publishers (websites) through various technologies, such as API feeds, banners, widgets, and the like. In one example, an affiliate network offers a service and retains a portion of the revenue paid out from the advertiser to the publisher.

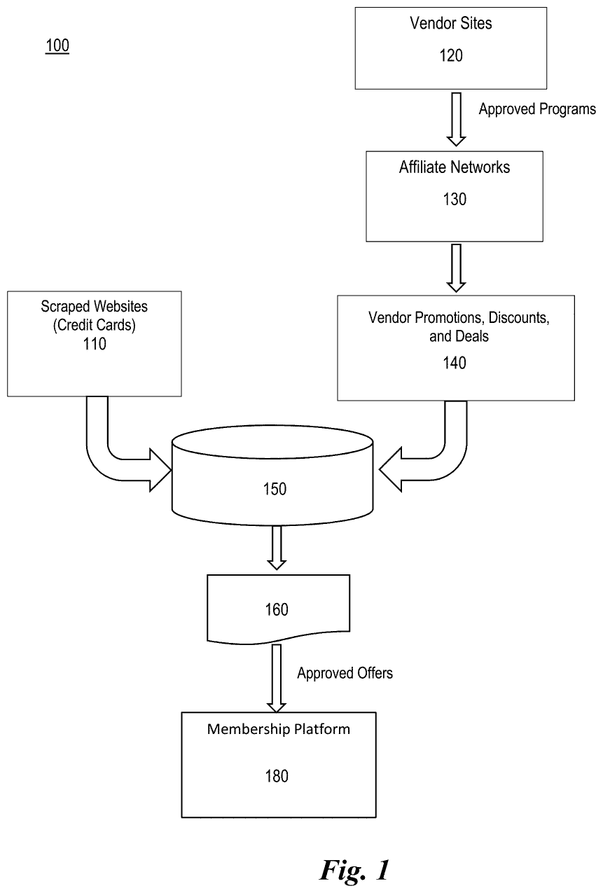

Referring now to the drawings in general, and to FIG. 1 in particular, we show a high-level overview of a discount optimization system, according to an embodiment. The system 100 of FIG. 1 presents a technological improvement over the current state of the art, thereby enabling a consumer to combine all available discounts, offers, and promotions for a credit card discount that is larger than if the user were to use only one source. The invention allows for faster, constantly updated, and voluminous data capture, storage, and analysis in order to produce the most optimized combined discount to the user. The invention combines credit card discounts dynamically scraped from credit card websites 110 and adds additional layers of discounts from vendor sites 120 and affiliate networks 130, so the user, when using the credit card, not only gets the credit card discount offered, but also the vendor discount, bank discount, and ultimately, the affiliate link discount/revenue 140 from an affiliate network 130. All of these discounts, offers, and deals are stored in the proprietary database 150. A Master List 160 of all available deals is produced. From this Master List 160, a subset of approved offers go on-line, available on the Membership Platform 180 for registered users.

By way of example, and not limitation, credit card XYZ offers a 10% discount if used at merchant ABC. Merchant ABC offers a 5% coupon code for purchases made through its website 120. The affiliate network 130 is affiliated with merchant ABC and shares 50% of the revenue paid from merchant ABC, which in this case is 50% of 6%. Assume User A makes a purchase with a price of $100. In an embodiment of the disclosure, the method utilizes the network-connected technology, processors, and databases to present to the user discounts to be applied, as follows:
1. First the credit card discount (10%);
2. Next the merchant discount (5%); and
3. The affiliate network discount (3%), as follows (if applied at checkout):

$100−$10−$5=$85−$2.55=$82.45 final cost to the user after application of the discounts.

In addition, through approved programs and as a member of a proprietary Membership Platform 180, once registered, if the program is also available through the affiliate network promotion feed, the user can get cash back from the Membership Platform 180, when the link is clicked on and a purchase is made.

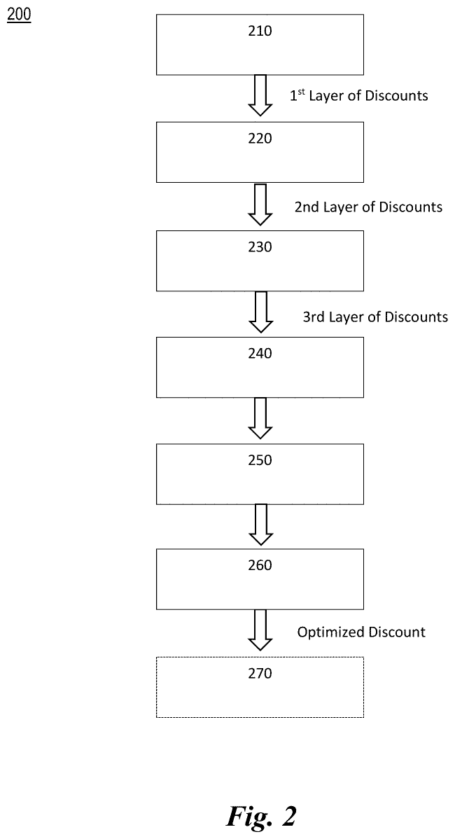

Referring now to FIG. 2, we show an operational flow diagram 200 of a process for optimizing discounts, according to an embodiment. We begin at step 210, where custom-programmed processors execute instruction sets to crawl websites for relevant content of discounts available on credit cards. This can include card issuer networks (Such as American Express®, Visa®, Discover®, and MasterCard®) and banks (such as Citibank®, Chase®, Bank of America®, and others). The custom-programmed processors extract, or “scrape” specific data, such as current verified credit card discounts, then works its way from that variable. This is automatically done via the instruction set running on the custom-programmed processor. Working recursively, the processors gather all available discounts, and write to a database the offers available for credit cards (such as VISA®, MasterCard®, American Express®), then, querying the database, match the credit card offers with merchants and credit card types. For example, if the system crawled the VISA website, it could scrape the VISA offers, and match all credit card offers that have “VISA” as their network. The output of this process is designated by the system as the first layer of discounts (credit cards).

Next, in step 220 the system, implemented through the custom-programmed processor running an instruction set, links the credit card discounts to merchant offers and discounts provided by the affiliate network 130. The output of this process is designated by the system as the second layer of discounts (merchants).

In step 230 the discounts are approved via an approval module and, once approved, discounts are matched with advertiser programs found in the Affiliate Network 130, which through an API (application program interface) promotional feed, are then linked to discounts that were scraped in steps 210 and 220 above. The output of this process is designated by the system as the third layer of discounts. This adds another layer of discounts to a registered user, that is not visible online to the consumer.

In step 240 the data gathered from the previous steps is then imported into the proprietary database 150, which is managed through a website interface, and stored in the proprietary database 150. This is automatically done. The website presents a user-interface to users to browse and compare credit card offers throughout every major category in the industry. The website provides a credit card information module and a comparison tool module for comparing credit cards in different categories, such as best card for travel perks, best credit card for boosting your credit score, best credit cards for earning cash bank, and the like.

In step 250 a review module prepares the data for editorial review. An editorial team utilizes the review module and reviews the data, and flags what can be used, not used, and makes minor modifications to the content, if required, prior to going live on the website. Once all offers are combined within the system, they are then visible only in the Membership Platform 180 area of the website via registered user login. The user registration can be made available for free, or it can be monetized. When someone registers through a registration module, and completes a verification step, they are then approved for the Membership Platform 180, they can then log into the account, and view discounts by Credit Card or by Vendors.

In step 260 an optimized discount is applied. The user can click on a link, and depending on the offer, may be required to manually enter the coupon code, or the discounts will be automatically applied. This varies by offer and service provided by vendors.

In step 270 a reward is applied to the user's account. In the event the optimized discount was also an affiliate link, then the user will earn a reward from the proprietary site, in addition to the discounts applied. If the discount was part of an incentive, the user may get cash back from the checkout process, viewable in the Membership Platform 180.

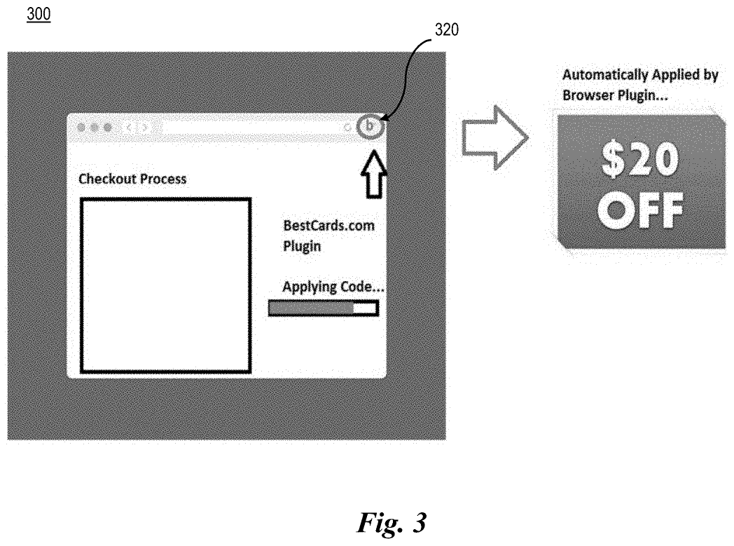

Referring now to FIG. 3, a browser plugin 320 is used to apply discounts, according to another embodiment of the disclosure. Instead of the consumer having to log into the Membership Platform 180, the browser plugin 320 is an instruction set configured to be executed by the browser application to connect to the system backend, and automatically applies the discounts to the user's shopping cart and/or gives the user the option to use the discounts applicable. This can also appear as a pop-up when the user is at the vendor's site, letting the user know of the different discounts that are available, combined through the method of FIG. 2.

In another embodiment of the disclosure, the system incorporates the method of FIG. 2 and emails the user based on the user's prior activities, whether through actions performed through the browser plugin 320 or activity in the membership platform 180, the system sends special discounts via email and/or newsletters.

In another embodiment of the disclosure, the system provides an API feed of all combined discounts that could then be incorporated and offered to other websites. In another embodiment of the disclosure, the system provides a mobile phone application to be used on both Apple iPhone® and Samsung Android® phones (or similar). The phone app is configured to interface with the GPS module of the mobile device and adds a location feature so the user is notified when at a specific location, such as a restaurant, gas station, store, etc . . . that the user would then be able to use the phone app to determine the best credit card to use at the location. In this way, the system has provided a technological improvement to the user's mobile device.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims. Modifications and changes to the invention should be readily apparent to those having ordinary skill in the art, which modifications are intended to be within the spirit and scope of the invention as claimed. It is also understood that the foregoing description is illustrative of the present invention and should not be considered as limiting. Components from one embodiment can be combined with another embodiment and remain within the spirit and scope of the invention. Therefore, other embodiments of the present invention are possible without departing from the spirit and scope of the present invention.

1. A discount optimization system comprising:
a network-connected computer backend with a processor, a storage, and a database where,
credit card discounts from credit card websites are collected and stored in the database,
vendor discounts from vendor sites are collected and stored in the database, and
affiliate discounts from affiliate networks are collected and stored in the database;
a master list of all available deals is produced by the processor by comparing all of the discounts collected and stored in the database;
a user-accessible front-end whereby the master list is presented to a user.

2. The discount optimization system of claim 1 further comprising a membership platform for registered users whereby a subset of approved offers from the master list is presented to the user.

3. The discount optimization system of claim 1 where the user-accessible front-end is a computer program product configured to be a browser plug-in that runs an instruction set whereby the discount optimization system interfaces with content present in the browser.

4. The discount optimization system of claim 2 where the user receives cash back from the membership platform.

5. A computer-implemented method for automatically identifying, curating, aggregating, and applying multiple discounts as one optimal credit card discount for use in an online shopping environment, the method comprising:
providing processors that are custom-programmed to execute instruction sets to crawl internet-accessible websites for relevant content of discounts available on credit cards;
recursively gathering by the custom-programmed processors all available discounts;
extracting by the custom-programmed processors of the relevant credit card discount data;
writing by the custom-programmed processors of the extracted credit card data to a database
providing merchant offers and discounts as additional data that is written to the database;
querying the database and matching the credit card offers with merchants and credit card types.
linking the credit card discounts to merchant offers and discounts provided by an affiliate network;
approving of discounts via an approval module;
matching of approved discounts with advertiser programs from the affiliate network;
linking of the matched approved discounts to the scraped discounts through an application program interface promotional feed;
automatically storing of the scraped, approved, matched, and linked discount data into a proprietary database;
providing an review module, whereby the data is prepared for editorial review;
providing a registration module for a user to be approved to access a membership platform;
presenting the membership platform via a user-interface to a user, whereby the user-interface is configured to enable a user to browse and compare credit card offers sorted by category via a credit card information module and a comparison tool module;
applying of an optimized discount; and
applying of a reward to the user's account.

6. The computer-implemented method of claim 5, wherein, the custom-programmed processors perform object —character recognition and language processing on the crawled websites to parse the information on the websites into a computer-understandable format.

7. The computer-implemented method of claim 5 additionally comprising the step of providing a browser plugin comprising an instruction set configured to be executed by the browser application to connect to the system backend, and automatically apply the discounts to the user's shopping cart or give the user the option to use the discounts available.

8. The computer-implemented method of claim 5 further comprising the step of emailing the user specialized content based upon the user's prior activities.

9. The computer-implemented method of claim 5 further comprising providing an API feed of all combined discounts that could then be incorporated and offered to other websites.

10. The computer-implemented method of claim 5 further comprising the step of providing a mobile phone application configured to interface with the GPS module of the mobile device and adds a location feature so that the user is notified when at a specific location such that the user would then be able to use the phone app to determine the best credit card to use at the location.

11. The computer-implemented method claim 5 where the method is packaged as a processor-executable instruction set computer program product.
